(19) United States
(12) Patent Application Publication
(10) Pub. No.: US 2026/0296179 A1
(43) Pub. Date: Oct. 1, 2026

(54) CONCEALED LINKAGE SYSTEMS FOR FUEL/CHARGE PORT DOOR ASSEMBLIES

(71) Applicant: FORD GLOBAL TECHNOLOGIES, LLC, Dearborn, MI (US)

(72) Inventor: HECTOR RAMIREZ LUGO, Metepec (MX)

(21) Appl. No.: 19/090,992

(22) Filed: Mar. 26, 2025

(51) Int. Cl. B60K 15/05

(52) U.S. Cl. CPC B60K 15/05; B60K 2015/053

(57) ABSTRACT

A vehicle assembly may include a housing. A vehicle assembly may include a door arranged to cover at least a portion of the housing. A vehicle assembly may include a linkage system coupled to the door and to the housing and configured to guide movement of the door between a closed position and an open position; and wherein the linkage system includes a first set of links connected to the housing, a second set of links connected to the door, and a first pivot joint that pivotably connects the first set of links to the second set of links.

### TECHNICAL FIELD

This disclosure relates to vehicle assemblies, and more particularly to vehicle charge port/fuel housing assemblies that include a door assembly and a linkage system for facilitating a wider opening of the door assembly.

### BACKGROUND

Motor vehicles typically include fuel fill and/or charging port access doors that are configured to rotate between closed and open positions via a hinge assembly. Some hinge assemblies include gooseneck hinges.

### SUMMARY

In some aspects, the techniques described herein relate to a vehicle assembly, including: a housing; a door arranged to cover at least a portion of the housing; a linkage system coupled to the door and to the housing and configured to guide movement of the door between a closed position and an open position; and wherein the linkage system includes a first set of links connected to the housing, a second set of links connected to the door, and a first pivot joint that pivotably connects the first set of links to the second set of links.

In some aspects, the techniques described herein relate to a vehicle assembly, wherein the first set of links includes a third connecting link mounted to the housing, a first connecting link pivotably mounted to the third connecting link at a first auxiliary pivot joint, and a second connecting link pivotably mounted to the third connecting link at a second auxiliary pivot joint.

In some aspects, the techniques described herein relate to a vehicle assembly, wherein the second set of links includes a fourth connecting link mounted to the door, a fifth connecting link pivotably mounted to the fourth connecting link at a third auxiliary pivot joint, and a sixth connecting link pivotably mounted to the fourth connecting link at a fourth auxiliary pivot joint.

In some aspects, the techniques described herein relate to a vehicle assembly, wherein the first pivot joint pivotably connects the sixth connecting link to the first connecting link.

In some aspects, the techniques described herein relate to a vehicle assembly, wherein the linkage system further includes an additional auxiliary pivot joint that pivotably connects the second connecting link and the sixth connecting link.

In some aspects, the techniques described herein relate to a vehicle assembly, wherein the linkage system further includes an additional auxiliary pivot joint that pivotably connects the first connecting link to the fifth connecting link.

In some aspects, the techniques described herein relate to a vehicle assembly, wherein the third connecting link includes a first support mount mounted to an upper section of the housing, and the fourth connecting link includes a second support mount mounted to an interior portion of the door.

In some aspects, the techniques described herein relate to a vehicle assembly, wherein the linkage system is a 6-bar linkage system.

In some aspects, the techniques described herein relate to a vehicle assembly, wherein, in the closed position of the door, the linkage system is retracted inwardly and is concealed inside the housing.

In some aspects, the techniques described herein relate to a vehicle assembly, wherein, in the open position of the door, the linkage system is angled in a direction further away from the housing.

In some aspects, the techniques described herein relate to a vehicle assembly, wherein, in the open position of the door, the first connecting link and the second connecting link are contracted toward one another, and the fifth connecting link and the sixth connecting link are contracted toward one another.

In some aspects, the techniques described herein relate to a vehicle assembly, wherein, in the open position of the door, the first connecting link, the second connecting link, the fifth connecting link, and the sixth connecting link are closer to parallel to one another than when the door is in the closed position.

In some aspects, the techniques described herein relate to a vehicle assembly, wherein the door is movable over an angular swing path of about 120-degrees when moved from the closed position to the open position.

In some aspects, the techniques described herein relate to a vehicle assembly, including: a housing; a door arranged to cover at least a portion of the housing; a linkage system coupled to the door and to the housing and configured to guide movement of the door between a closed position and an open position; and wherein the linkage system includes a first connecting link and a second connecting link that are pivotably mounted relative to the housing at a third connecting link, and a fifth connecting link and a sixth connecting link that are pivotably mounted relative to the door at a fourth connecting link.

In some aspects, the techniques described herein relate to a vehicle assembly, wherein the door is movable over an angular swing path of about 120-degrees when moved from the closed position to the open position.

In some aspects, the techniques described herein relate to a vehicle assembly, wherein the first connecting link is pivotably mounted to the third connecting link at a first auxiliary pivot joint, and the second connecting link is pivotably mounted to the third connecting link at a second auxiliary pivot joint.

In some aspects, the techniques described herein relate to a vehicle assembly, wherein the fifth connecting link is pivotably mounted to the fourth connecting link at a third auxiliary pivot joint, and the sixth connecting link is pivotably mounted to the fourth connecting link at a fourth auxiliary pivot joint.

In some aspects, the techniques described herein relate to a vehicle assembly, wherein the linkage system further includes an additional auxiliary pivot joint that pivotably connects the second connecting link and the sixth connecting link.

In some aspects, the techniques described herein relate to a vehicle assembly, wherein the linkage system further includes an additional auxiliary pivot joint that pivotably connects the first connecting link to and fifth connecting link.

In some aspects, the techniques described herein relate to a vehicle assembly, wherein the linkage system further includes a first pivot joint that pivotably connects the sixth connecting link and the first connecting link.

### BRIEF DESCRIPTION OF THE DRAWINGS

FIG. 1 illustrates a vehicle equipped with a charge port housing assembly.

FIG. 2 illustrates an exploded view of the charge port housing assembly of the vehicle of FIG. 1.

FIG. 3 illustrates a linkage system of the charge port housing assembly of FIGS. 1 and 2.

FIG. 4 illustrates a closed position of the charge port housing assembly of FIG. 1.

FIG. 5 illustrates an open position of the charge port housing assembly of FIG. 1.

FIG. 6 illustrates a fully open position of the charge port housing assembly of FIG. 1.

FIG. 7 illustrates a blown-up view of the charge port housing assembly in use of FIG. 1.

FIG. 8 illustrates select portions of a vehicle equipped with a fuel fill housing assembly.

### DETAILED DESCRIPTION

This disclosure is directed to vehicle assemblies that include concealed linkage systems. Examples of vehicle assemblies with concealed linkage systems include charge port housing assemblies and fuel fill housing assemblies. An exemplary vehicle assembly may include an access door assembly and a linkage system for guiding movement of the access door assembly between closed and opened positions. The linkage system may include a first set of links and a second set of links that cooperate to allow the access door assembly to open at a larger angle. These and other features of this disclosure are described in greater detail below.

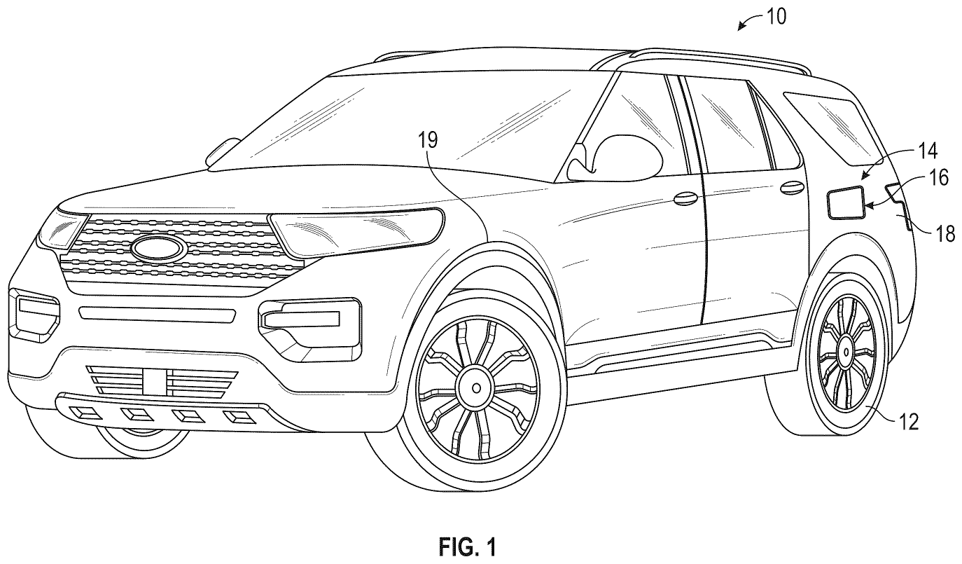

FIG. 1 illustrates an exemplary motor vehicle 10 (hereinafter “the vehicle”). In an embodiment, the vehicle 10 is an electrified vehicle that includes an electrified powertrain capable of applying a torque from an electric machine for driving drive wheels 12 of the vehicle 10. The vehicle 10 may be a plug-in hybrid electric vehicle (PHEV) or a battery electric vehicle (BEV), for example. Therefore, the powertrain may electrically propel the drive wheels 12, either with or without the assistance of an internal combustion engine.

The vehicle 10 of FIG. 1 is schematically illustrated as a sport utility vehicle (SUV). However, the teachings of this disclosure may be applicable to any style of vehicle, including but not limited to, cars, trucks, vans, SUVs, etc.

Although a specific component relationship is illustrated in the figures of this disclosure, the illustrations are not intended to limit this disclosure. The placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

The vehicle 10 may include a charge port housing assembly 14 configured for charging the energy storage devices (e.g., battery cells of a traction battery pack) of the vehicle 10. The charge port housing assembly 14 may include a door assembly 16 movably mounted relative to a vehicle body component 18. For example, the door assembly 16 may be movable between closed and open positions for blocking or accessing a charge port of the charge port housing assembly 14.

In an embodiment, the vehicle body component 18 is a rear quarter panel of the vehicle 10. However, the charge port housing assembly 14 could be arranged elsewhere on the vehicle 10, such as within a front fender 19 of the vehicle 10, for example.

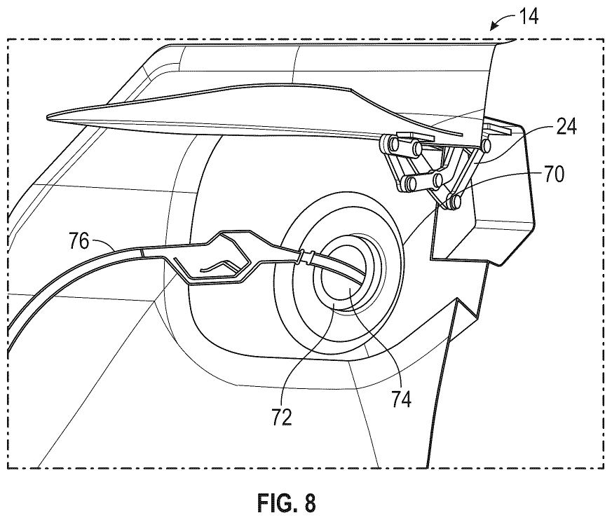

Although the door assembly 16 is described in associated with the charge port housing assembly 14, a similar door assembly could be incorporated into a conventional vehicle that relies on an internal combustion engine for propulsion. Such a vehicle can be refueled through a fuel filler. That is, the teachings of this disclosure, although described in connection with the charge port housing assembly 14, are also applicable to fuel fill housing assemblies (see, e.g., FIG. 8).

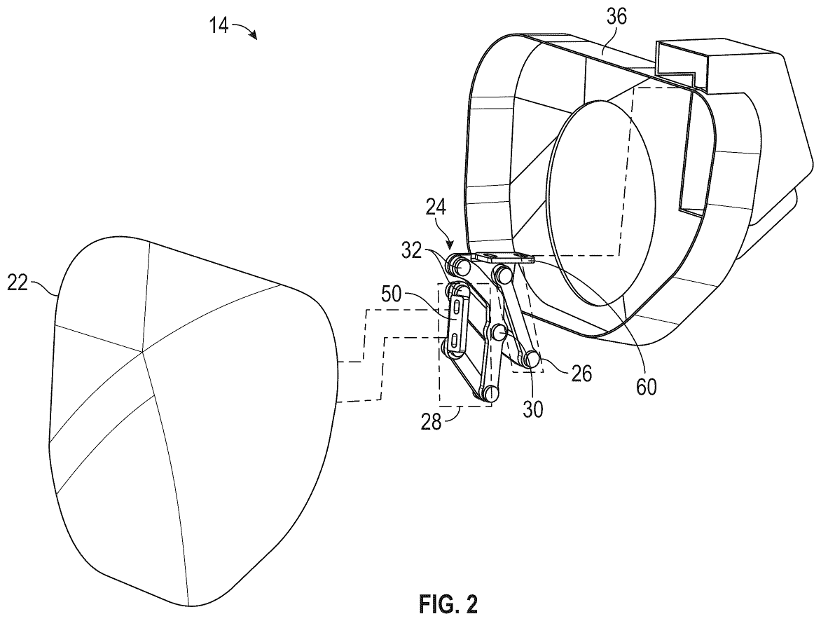

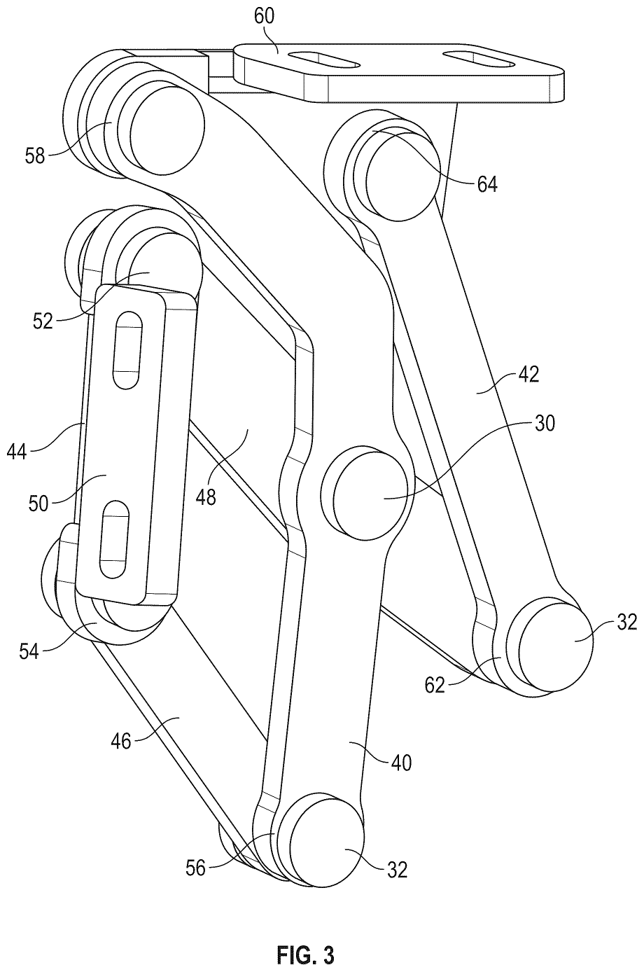

Referring now to FIGS. 2-6, the door assembly 16 may include a door 22 and a linkage system 24 that is connected to both the door 22 and a housing 36. The housing 36 may be the portion of the charge port housing assembly 14 that is mounted to the vehicle body component 18, for example. The linkage system 24 pivotably connects the door 22 for movement relative to the housing 36 between closed and open positions.

The linkage system 24 may include a first set of links 26, a second set of links 28, a first pivot joint 30, and a plurality of auxiliary pivot joints 32. The first set of links 26 and the second set of links 28 may be operably connected together by the first pivot joint 30 to guide movement of the door 22 between the closed and open positions. The first set of links 26 may be pivotably connected to an upper portion 34 of the housing 36, and the second set of links 28 may be connected to an inner portion 38 of the door 22.

The first set of links 26 of the linkage system 24 may include a first connecting link 40, a second connecting link 42, and a third connecting link 43. The second set of links 28 of the linkage system 24 may include a fourth connecting link 44, a fifth connecting link 46, and a sixth connecting link 48. The linkage system 24 may therefore be referred to as a 6-bar linkage system.

The first connecting link 40, the second connecting link 42, the third connecting link 43, the fourth connecting link 44, the fifth connecting link 46, and the sixth connecting link 48 may share some common auxiliary pivot joints 32. Each auxiliary pivot joint 32 may provide a location at which the linkage system 24 is capable of pivoting or otherwise articulating in order to guide movement of the door 22 between the closed and open positions.

The third connecting link 43 may include a first support mount 60 adapted for mounting the linkage system 24 to the housing 36. Specifically, the first support mount 60 may be positioned on the upper portion 34 of the housing 36. Mechanical fasteners (not shown) may be utilized to mount the first support mount 60 of the third connecting link 43 to the upper portion 34 of the housing 36.

The fourth connecting link 44 may include a second support mount 50 adapted for mounting the linkage system 24 to the door 22. Specifically, the second support mount 50 may be positioned at the inner portion 38 of the door 22. Mechanical fasteners (not shown) may be utilized to mount the second support mount 50 of the fourth connecting link 44 to the inner portion 38 of the door 22.

The third connecting link 43 may include one auxiliary pivot joint 32 located at each of its opposite ends 45, 47. The first connecting link 40 may be pivotably connected to the third connecting link 43 by the auxiliary pivot joint 32 located at the end 45, and the second connecting link 42 may be pivotably connected to the third connecting link 43 by the auxiliary pivot joint 32 located at the end 47.

The fourth connecting link 44 may include one auxiliary pivot joint 32 located at each of its opposite ends 52, 54. The fifth connecting link 46 may be pivotably connected to the fourth connecting link 44 by the auxiliary pivot joint 32 located at the end 54, and the sixth connecting link 48 may be pivotably connected to the fourth connecting link 44 by the auxiliary pivot joint 32 located as the end 52.

The first connecting link 40 may be pivotably connected to the sixth connecting link 48 by the first pivot joint 30. The first pivot joint 30 may be about centrally located between opposite ends of the first connecting link 40 and about centrally located between opposite ends of the sixth connecting link 48. The first connecting link 40 and the sixth connecting link 48 may extend at transverse angles relative to one another via the first pivot point 30.

The first connecting link 40 may additionally be pivotably connected to the fifth connecting link 46 by another one of the auxiliary pivot joints 32. The second connecting link 42 may additionally be pivotably connected to the sixth connecting link 48 by yet another one of the auxiliary pivot joints 32.

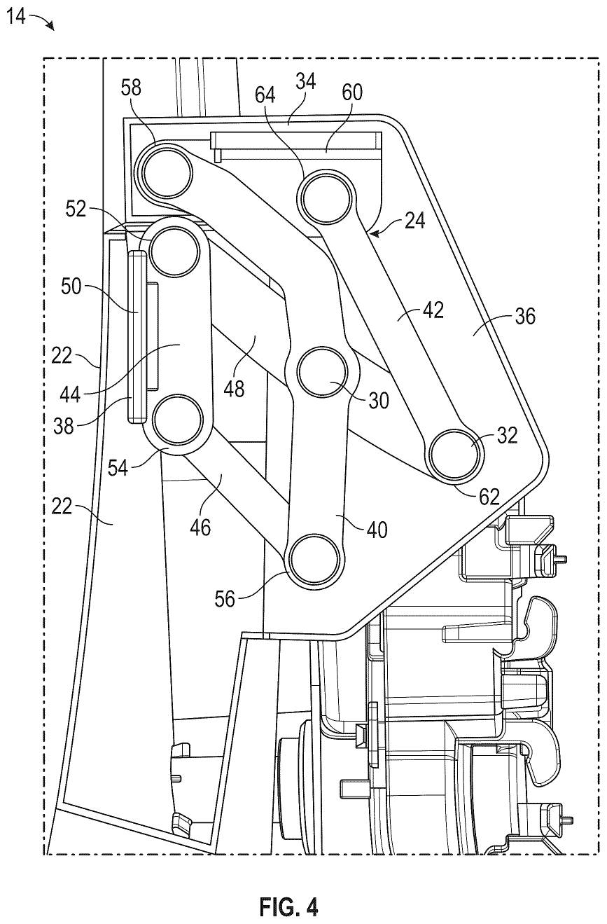

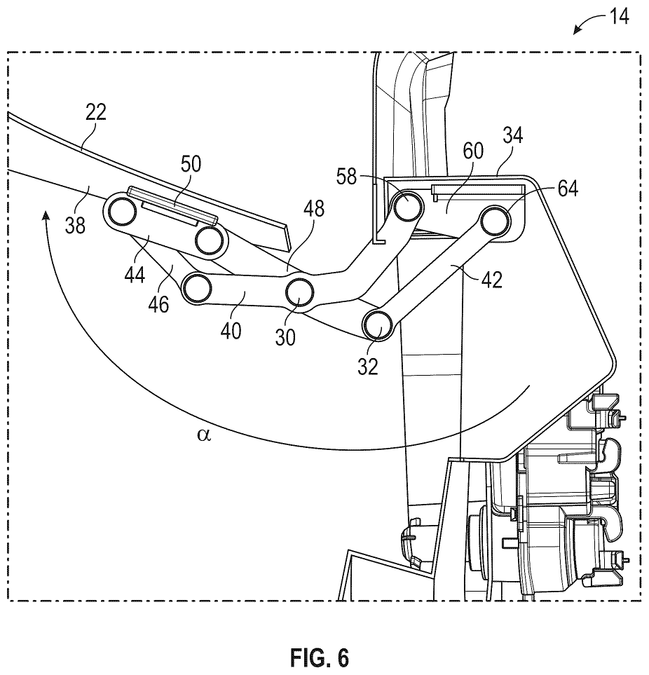

Referring now primarily to FIGS. 4-6, the linkage system 24 is capable of guiding movement of the door 22 between the closed position of FIG. 4 and the fully open position of FIG. 6. In the closed position, the door 22 of the door assembly 14 is positioned inwardly to fully cover the linkage system 24 and the housing 36 such that the linkage system 24 is completely concealed from view. The linkage system 24 is contracted down in a non-expanded manner and is oriented inwardly at a slight angle when the door 22 is in the closed position.

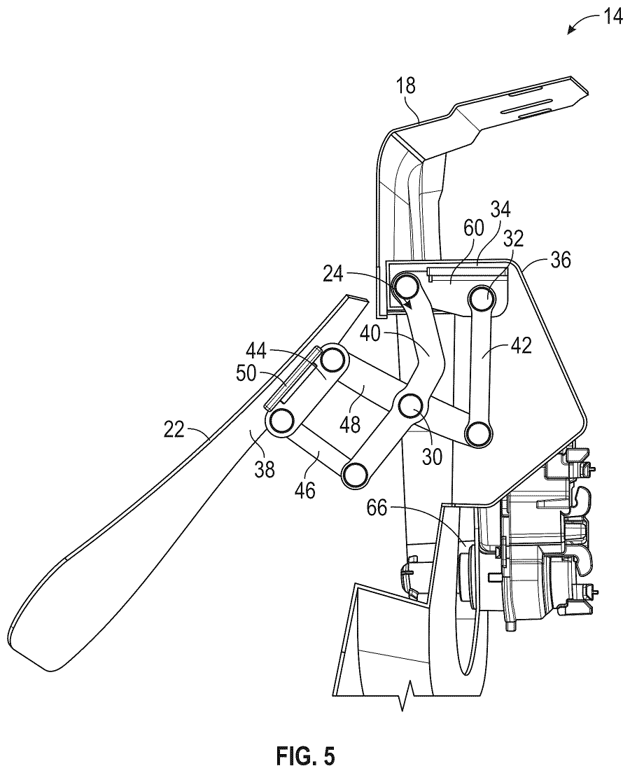

The door 22 is shown in a partially open position in FIG. 5. The linkage system 24 may pivot about the first pivot point 30 and at least the auxiliary pivot points 32 provided by the third connecting link 43 to move from the closed position of FIG. 4 to the partially open position of FIG. 5. The first connecting link 40, the fifth connecting link 46, and the sixth connecting link 48 may begin to angle in a direction away from the housing 36 as the door 22 is moved toward the partially open position of FIG. 5.

As the door 22 is continued to be moved from the partially open position of FIG. 5 to the fully open position of FIG. 6, the linkage system 24 may continue to pivot about the first pivot point 30 and each of the auxiliary pivot points 32. The first connecting link 40, the second connecting link 42, the fifth connecting link 46, and the sixth connecting link 48 may each move in a direction further away from the housing 36 as the door 22 is moved toward the fully open position of FIG. 6. The first connecting link 40 and the second connecting link 42 may contract or move toward one another and the fifth connecting link 46 and the sixth connecting link 48 may contract or move toward one another as the door 22 is continued to be moved to the fully open position of FIG. 6. Further, the first connecting link 40, the second connecting link 42, the fifth connecting link 46, and the sixth connecting link 48 may be moved into a position of being closer to parallel with one another as the door 22 is moved further toward the fully open position of FIG. 6.

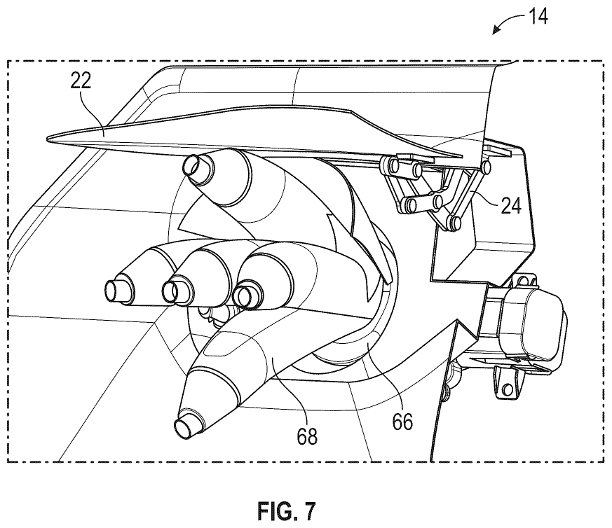

The door 22 may be moved across an angular swing path α of about 120-degrees to reach the fully open position of FIG. 6. In this disclosure, the term “about” means that the expressed quantities or ranges need not be exact but may be approximated and/or larger or smaller, reflecting acceptable tolerances, conversion factors, measurement error, etc. The angular swing path α of about 120-degrees sufficiently exposes the housing 34 for allowing the use of a charging nozzle that requires a relatively larger opening for accessing the charge (see, e.g., the embodiment of FIG. 7).

FIG. 7 illustrates the linkage system 24 and the door 22 of the door assembly 14 when the door assembly 14 is in the fully open position. The 120-degree angle between the door 22 and the housing 34 provided by the fully open position sufficiently exposes a charge port opening 66 of the housing 34. A charge nozzle 68 may thus be inserted into the charge port opening 66 (and thus connect to a charge port provided therein) for charging the vehicle 10.

The linkage system 24 may also be applied to a fuel delivery system. FIG. 8 illustrates a fuel fill housing assembly 70, where the linkage system 24 and the door assembly 14 is in the fully open position. The fuel fill housing assembly 70 includes a fuel fill neck 72 and a fuel fill opening 74. The fuel fill neck 72 connects the fuel fill housing assembly 70 to the fuel fill opening 74. A fuel nozzle 76 may thus be inserted into the fuel fill opening 74 (and thus connect to a fuel port provided therein) for fueling the vehicle 10.

The linkage systems of this disclosure provide a wider angular opening compared to traditional gooseneck hinges. Additionally, the linkage systems also provide for a smooth and controlled motion achieving a 120-degree upward opening, thus improving mechanical stress on the individual components of a charge port or fuel port housing assembly. The versatility of the linkage system can be adapted for various vehicle models and types, providing a universal solution for fuel and charge port doors, thus eliminating the need for gooseneck hinges.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A vehicle assembly, comprising:
a housing;
a door arranged to cover at least a portion of the housing;
a linkage system coupled to the door and to the housing and configured to guide movement of the door between a closed position and an open position; and
wherein the linkage system includes a first set of links connected to the housing, a second set of links connected to the door, and a first pivot joint that pivotably connects the first set of links to the second set of links.

2. The vehicle assembly as recited in claim 1, wherein the first set of links includes a third connecting link mounted to the housing, a first connecting link pivotably mounted to the third connecting link at a first auxiliary pivot joint, and a second connecting link pivotably mounted to the third connecting link at a second auxiliary pivot joint.

3. The vehicle assembly as recited in claim 2, wherein the second set of links includes a fourth connecting link mounted to the door, a fifth connecting link pivotably mounted to the fourth connecting link at a third auxiliary pivot joint, and a sixth connecting link pivotably mounted to the fourth connecting link at a fourth auxiliary pivot joint.

4. The vehicle assembly as recited in claim 3, wherein the first pivot joint pivotably connects the sixth connecting link to the first connecting link.

5. The vehicle assembly as recited in claim 3, wherein the linkage system further includes an additional auxiliary pivot joint that pivotably connects the second connecting link and the sixth connecting link.

6. The vehicle assembly as recited in claim 3, wherein the linkage system further includes an additional auxiliary pivot joint that pivotably connects the first connecting link to the fifth connecting link.

7. The vehicle assembly as recited in claim 3, wherein the third connecting link includes a first support mount mounted to an upper section of the housing, and the fourth connecting link includes a second support mount mounted to an interior portion of the door.

8. The vehicle assembly as recited in claim 1, wherein the linkage system is a 6-bar linkage system.

9. The vehicle assembly as recited in claim 1, wherein, in the closed position of the door, the linkage system is retracted inwardly and is concealed inside the housing.

10. The vehicle assembly as recited in claim 9, wherein, in the open position of the door, the linkage system is angled in a direction further away from the housing.

11. The vehicle assembly as recited in claim 3, wherein, in the open position of the door, the first connecting link and the second connecting link are contracted toward one another, and the fifth connecting link and the sixth connecting link are contracted toward one another.

12. The vehicle assembly as recited in claim 11, wherein, in the open position of the door, the first connecting link, the second connecting link, the fifth connecting link, and the sixth connecting link are closer to parallel to one another than when the door is in the closed position.

13. The vehicle assembly as recited in claim 1, wherein the door is movable over an angular swing path of about 120-degrees when moved from the closed position to the open position.

14. A vehicle assembly, comprising:
a housing;
a door arranged to cover at least a portion of the housing;
a linkage system coupled to the door and to the housing and configured to guide movement of the door between a closed position and an open position; and
wherein the linkage system includes a first connecting link and a second connecting link that are pivotably mounted relative to the housing at a third connecting link, and a fifth connecting link and a sixth connecting link that are pivotably mounted relative to the door at a fourth connecting link.

15. The vehicle assembly as recited in claim 14, wherein the door is movable over an angular swing path of about 120-degrees when moved from the closed position to the open position.

16. The vehicle assembly as recited in claim 14, wherein the first connecting link is pivotably mounted to the third connecting link at a first auxiliary pivot joint, and the second connecting link is pivotably mounted to the third connecting link at a second auxiliary pivot joint.

17. The vehicle assembly as recited in claim 16, wherein the fifth connecting link is pivotably mounted to the fourth connecting link at a third auxiliary pivot joint, and the sixth connecting link is pivotably mounted to the fourth connecting link at a fourth auxiliary pivot joint.

18. The vehicle assembly as recited in claim 17, wherein the linkage system further includes an additional auxiliary pivot joint that pivotably connects the second connecting link and the sixth connecting link.

19. The vehicle assembly as recited in claim 17, wherein the linkage system further includes an additional auxiliary pivot joint that pivotably connects the first connecting link to and fifth connecting link.

20. The vehicle assembly as recited in claim 14, wherein the linkage system further includes a first pivot joint that pivotably connects the sixth connecting link and the first connecting link.
